(19) United States
(12) Patent Application Publication
(10) Pub. No.: US 2023/0116752 A1
(43) Pub. Date: Apr. 13, 2023

(54) SYSTEMS AND METHODS FOR COMPOSTABLE BAGS

(71) Applicant: TRANSCONTINENTAL HOLDING CORP., Chicago, IL (US)

(72) Inventors: Thomas R. LEE, Appleton, WI (US); Jason MEYER, Fort Collins, CO (US)

(73) Assignee: TRANSCONTINENTAL HOLDING CORP., Chicago, IL (US)

(21) Appl. No.: 17/964,518

(22) Filed: Oct. 12, 2022

Related U.S. Application Data
(60) Provisional application No. 63/255,364, filed on Oct. 13, 2021.

(51) Int. Cl. B32B 37/15; B32B 37/04; B32B 37/02; B32B 7/08; B32B 27/08; B32B 27/30

(52) U.S. Cl. CPC B32B 37/153; B32B 37/04; B32B 37/02; B32B 7/08; B32B 27/08; B32B 27/306; B32B 2250/03; B32B 2250/05; B32B 2250/24; B32B 2250/44; B32B 2250/40; B32B 2307/414; B32B 2307/54; B32B 2307/558; B32B 2307/732; B32B 2307/7265; B32B 2307/7244; B32B 2307/7246; B32B 2307/7163; B32B 2307/7166; B32B 2553/00; B32B 2317/20

(57) ABSTRACT

A film structure includes a first outer layer system, a second outer layer system, and a core layer system. The first outer layer system includes at least one layer formed of a starch polymer thermoplastic bioresin. The second outer layer system includes at least one layer formed of a starch polymer thermoplastic bioresin. The core layer system includes at least one layer formed of a modified Polyvinyl Alcohol (PVOH). The first outer layer system, the second outer layer system, and the core layer system are compostable.

This application claims the benefit of and priority to U.S. Provisional Patent Application No. 63/255,364, filed Oct. 13, 2021, which is hereby incorporated by reference in its entirety.

### TECHNICAL FIELD

The present disclosure relates generally to flexible packaging films, and more particularly relates to compostable films and bags, and related methods for making compostable films and bags.

### BACKGROUND

Flexible packaging films have been used to create barriers that protect perishable goods (e.g., food) during transportation and storage of the perishable goods such as between a producer to a consumer. For example, films may include polymeric materials to prevent the passage of molecules including, for example, gases and water vapor, to protect the perishable goods from the deleterious effects of such gases and water vapors. The films are typically coextruded by feeding layers of polymeric materials into a feed block where they are arranged into a layered configuration prior to extrusion through a die. Each layer is typically configured to protect the perishable goods from a certain type of contamination or to tie the layers together. For example, some layers may be better suited to protecting the perishable goods from water vapor while some layers may be better suited to protecting the perishable goods from oxygen. Generally, the combination of the layers forms a strong protective barrier that resists degradation from oxygen, water vapor, and other environmental factors for an extended period of time to ensure that the perishable goods within are also protected. However, these layers also prevent the films and storage containers made from the films from degrading or composting for a very long time after the containers have served their purpose. For example, some containers that include the above described films can resist degradation and composting for hundreds of years, cluttering landfills and increasing pollution.

For the foregoing reasons, there is a need to provide improved film structures that quickly degrade and compost.

### SUMMARY

One aspect of the present disclosure relates a film structure includes a first outer layer system, a second outer layer system, and a core layer system. The first outer layer system includes at least one layer formed of a starch polymer thermoplastic bioresin. The second outer layer system includes at least one layer formed of a starch polymer thermoplastic bioresin. The core layer system includes at least one layer formed of a modified Polyvinyl Alcohol (PVOH). The first outer layer system, the second outer layer system, and the core layer system are compostable.

Another aspect of the present disclosure relates to a film structure includes a first outer layer system, a second outer layer system, and a core layer system. The first outer layer system includes at least one layer formed of a starch polymer thermoplastic bioresin and configured to resist permeation of at least one of water vapor and oxygen through the first outer layer system within a first temperature and/or humidity range. The second outer layer system includes at least one layer formed of a starch polymer thermoplastic bioresin and configured to resist permeation of at least one of water vapor and oxygen through the second outer layer system within the first temperature and/or humidity range. The core layer system includes at least one layer formed of a modified Polyvinyl Alcohol (PVOH) and configured to resist permeation of oxygen through the core layer system within the first temperature and/or humidity range. The first outer layer system, the second outer layer system, and the core layer system are compostable within a second temperature and/or humidity range.

The present disclosure also is directed to a method of manufacturing a film structure with an extrusion system. The extrusion system includes a plurality of extruders, a feedblock, and a die. The method includes extruding at least one first material using the extruders to generate at least one first melt stream. The method also includes feeding the first melt stream to the feedblock. The first melt stream forms a first outer layer system. The method further includes extruding at least one second material using the extruders to generate at least one second melt stream. The method also includes feeding the second melt stream to the feedblock. The second melt stream forms a core layer system. The method further includes extruding at least one third material using the extruders to generate at least one third melt stream. The method also includes feeding the third melt stream to the feedblock. The third melt stream forms a second outer layer system. The method further includes combining the first outer layer system, the core layer system, and the second outer layer system to form a combined melt stream using the feedblock. The method also includes feeding the combined melt stream through a die to form a cylindrical sheet. The first outer layer system, the core layer system, and the second outer layer system are compostable.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a block flow diagram of an example extrusion system in accordance with the present disclosure.

FIG. 2 is a perspective view of a bag manufactured using the extrusion system illustrated in FIG. 1 in accordance with the present disclosure.

FIG. 3 is a schematic cut-away/cross-sectional view of a film manufactured using the extrusion system illustrated in FIG. 1 in accordance with the present disclosure.

FIG. 4 is a schematic cut-away/cross-sectional view of a film manufactured using the extrusion system illustrated in FIG. 1 in accordance with the present disclosure.

FIG. 5 is a flow diagram illustrating an example method of manufacturing the films and bags illustrated in FIGS. 2-4 with the extrusion system illustrated in FIG. 1 in accordance with the present disclosure.

FIG. 6 is a graph of the results tabulated in Tables 11 and 12 in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The bags described herein are formed of a film including a plurality of layers with physical properties that enable the bags and the films to protect perishable goods within a first temperature and/or humidity range and enable the bags and the films to compost within a second temperature and/or humidity range. Specifically, the films described herein include a first outer layer system, a second outer layer system, and a core layer system. The first outer layer system and the second outer layer system are configured to protect the core layer system and the perishable goods from water vapor permeation and the core layer system is configured to protect the perishable goods from oxygen permeation through the film. The first and second outer layer system are positioned on either side of the core layer system such that the first and second outer layer system protect the core layer system from water vapor. Additionally, the core layer system has increased resistance to oxygen permeation but is water soluble while the first and second outer layer system have increased resistance to water vapor permeation and decreased resistance to oxygen permeation when compared to the core layer system. Thus, the sandwich structure of the films enables the core layer system that is water soluble to be protected by the first and second outer layer system, preventing the core layer system from disintegration due to water vapor.

Moreover, the first and second outer layer system and the core layer system have increased resistance to water vapor permeation and oxygen permeation within the first temperature and/or humidity range and decreased resistance to water vapor permeation and oxygen permeation within the second temperature and/or humidity range. The first temperature and/or humidity range is typically refrigeration conditions such that the films may be used to protect perishable goods when refrigerated. The second temperature and/or humidity range is typically non-refrigeration conditions such that the bags and films described herein compost when not in use and not refrigerated. Specifically, the first and second outer layer system have reduced resistance to water vapor permeation within the second temperature and/or humidity range such that the core layer system is exposed to water vapor and disintegrates when the films and bags described herein are maintained within the second temperature and/or humidity range. Accordingly, the bags and films described herein are capable of preserving perishable goods when refrigerated and are compostable when not in use, decluttering landfills and reducing pollution.

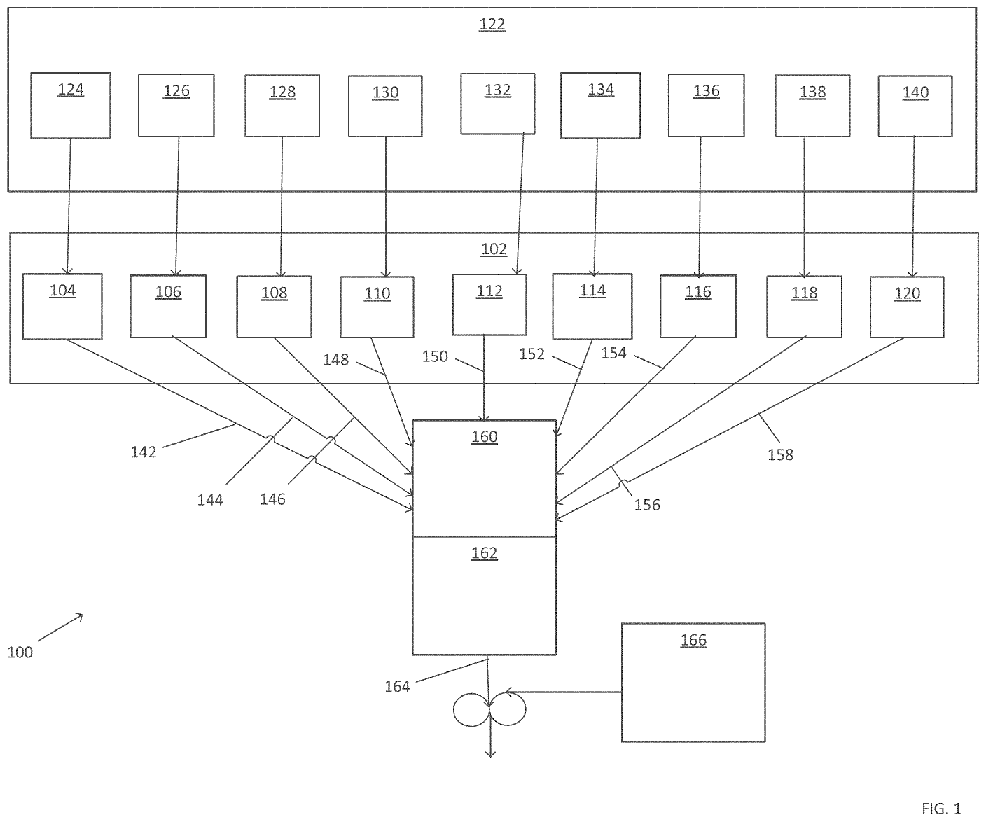

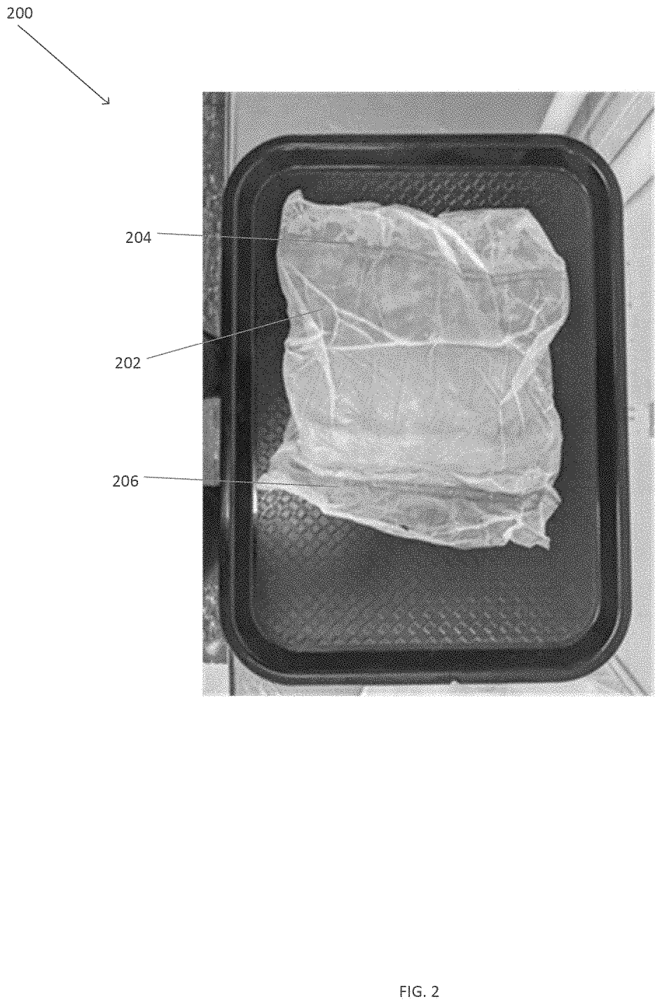

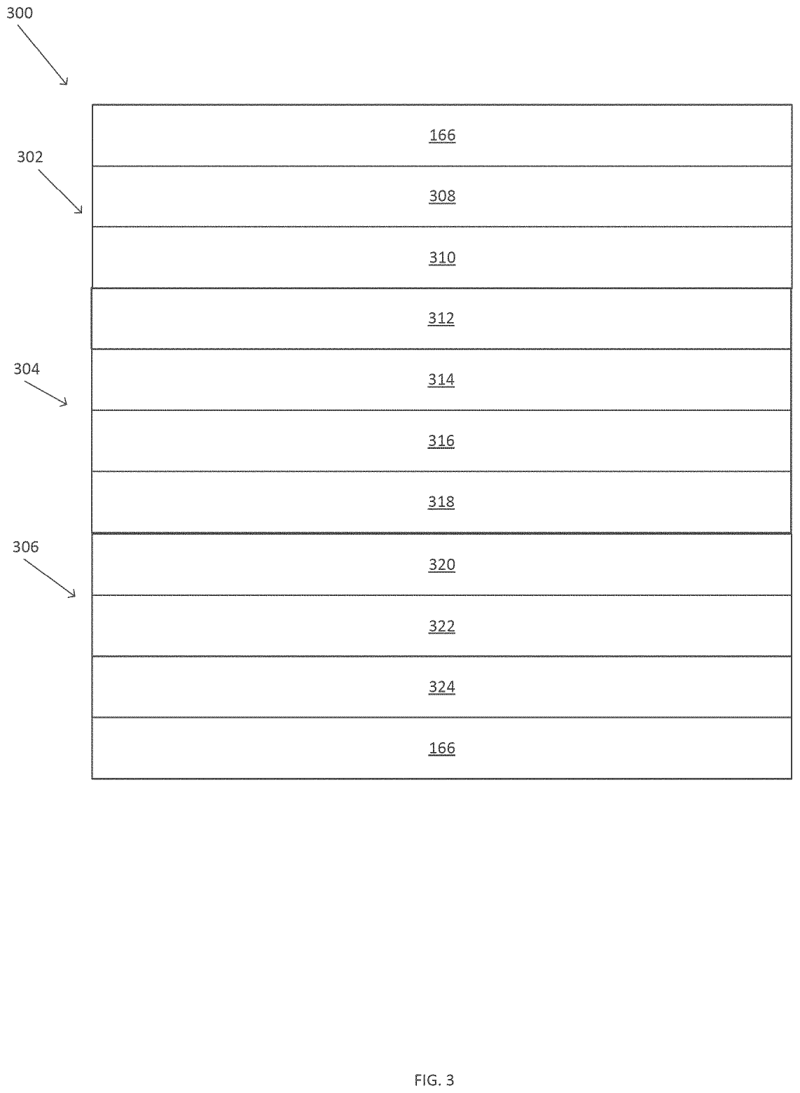

Referring now to the drawings wherein like numerals refer to like parts, FIG. 1 illustrates an extrusion system 100 for manufacturing a bag 200 formed of a film 300 (shown in FIGS. 2 and 3). The extrusion system 100 may include a plurality of extruders 102 that may melt and extrude a material into a melt stream. More specifically, in the illustrated embodiment, the extrusion system 100 includes at least five extruders. In the illustrated embodiment, the extrusion system 100 includes at least nine extruders 104, 106, 108, 110, 112, 114, 116, 118, and 120. In the illustrated embodiment, the extrusion system 100 includes a first extruder 104, a second extruder 106, a third extruder 108, a fourth extruder 110, a fifth extruder 112, a sixth extruder 114, a seventh extruder 116, an eighth extruder 118, and a ninth extruder 120. As described herein, the first, second, and third extruders 104-108 are configured to extrude a first outer layer system 302 (shown in FIG. 3) of the film 300, the fourth, fifth, and sixth extruders 110-114 are configured to extrude a core layer system 304 (shown in FIG. 3) of the film 300, and the seventh, eighth, and ninth extruders 116-120 are configured to extrude a second outer layer system 306 (shown in FIG. 3) of the film 300. Additionally, the film 300 may have any number of layers that enables the film 300 to operate as described herein and the extrusion system 100 may have any number of extruders 102 that enable the extrusion system 100 to manufacture the film 300 described herein.

As shown in FIG. 1, the extruders 102 are each fed one of a plurality of materials 122. In the illustrated embodiment, the materials 122 include a first material 124, a second material 126, a third material 128, a fourth material 130, a fifth material 132, a sixth material 134, a seventh material 136, an eighth material 138, and a ninth material 140. As described above, the film 300 may have any number of layers that enables the film 300 to operate as described herein and the extruders 102 may be fed any number of materials that enable the extrusion system 100 to manufacture the film 300 described herein. In the illustrated embodiment, the first, second, and third materials 124-128 will form the first outer layer system 302 (shown in FIG. 3) of the film 300, the fourth, fifth, and sixth materials 130-134 will form the core layer system 304 (shown in FIG. 3) of the film 300, the seventh, eighth, and ninth materials 136-140 will form the second outer layer system 306 (shown in FIG. 3) of the film 300.

The extruders 102 each generate a melt stream 142, 144, 146, 148, 150, 152, 154, 156, and 158 from the materials 122. The extruders 102 are each configured to melt the materials 122 and extrude the materials 122 into the melt streams 142-158. Specifically, in the illustrated embodiment, the first extruder 104 melts and extrudes the first material 124 to generate a first melt stream 142, the second extruder 106 melts and extrudes the second material 126 to generate a second melt stream 144, the third extruder 108 melts and extrudes the third material 128 to generate a third melt stream 146, the fourth extruder 110 melts and extrudes the fourth material 130 to generate a fourth melt stream 148, the fifth extruder 112 melts and extrudes the fifth material 132 to generate a fifth melt stream 150, the sixth extruder 114 melts and extrudes the sixth material 134 to generate a sixth melt stream 152, the seventh extruder 116 melts and extrudes the seventh material 136 to generate a seventh melt stream 154, the eighth extruder 118 melts and extrudes the eighth material 138 to generate an eighth melt stream 156, and the ninth extruder 120 melts and extrudes the ninth material 140 to generate an ninth melt stream 158. As described above, the film 300 may have any number of layers that enables the film 300 to operate as described herein and the extruders 102 may generate any number of melt streams that enable the extrusion system 100 to manufacture the film 300 described herein.

In the illustrated embodiment, the extrusion system 100 further includes at least one feedblock 160 configured to combine the melt streams 142-158 in a way that results in a uniform layer distribution of the film 300. The feedblock 160 may include any feedblock technology that enables the extrusion system 100 to manufacture the film 300 described herein, including, but not limited to, vanes, laminar plates, plugs, pins, and other devices that enable the extrusion system 100 to manufacture the film 300 described herein. The melt streams 142-158 are combined by the feedblock 160 and transferred for further processing.

In the illustrated embodiment, the extrusion system 100 also includes a die 162 that receives the combined melt streams 142-158 to thin and spread the melt streams 142-158 into a cylindrical sheet 164. After the sheet 164 is produced, it may be laminated with one or more third outer layers 166 such as various substrates detailed below with reference to FIG. 3. During operations, the materials 122 are fed to the extruders 102 and the extruders 102 extrude the materials 122 into the melt streams 142-158. The melt streams 142-158 are then fed to the feedblock 160 and the feedblock 160 arranges the melt streams 142-158 into the uniform layer distribution of the film 300. The die 162 receives the combined melt streams 142-158 from the feedblock 160 and the die 162 thins and spreads the combined melt streams 142-158 into the cylindrical sheet 164. The cylindrical sheet 164 may then be laminated with one or more third outer layers 166. Additionally, the cylindrical sheet 164 are then sealed at one end 204 and 206 to form the bag 200.

FIG. 2 illustrates the improved bag 200 that may be produced by the extrusion system 100 described above with reference to FIG. 1. As shown in FIG. 2, the bag 200 includes the film 300 formed into a cylindrical body 202. The cylindrical body 202 has a first end 204 and a second end 206 and at least one of the first and second ends 204 and 206 is sealed to form the cylindrical body 202. The bag 200 may also include a sealing mechanism (not shown) attached to at least one of the first and second ends 204 and 206 to enable selective access to the bag 200. As described herein, the film 300 is compostable such that the bag 200 is also compostable. More specifically, as described herein, the film 300 is formed of materials that are compostable at predetermined temperatures and humidities and stable at other temperatures such that the bag 200 seals perishable materials within the bag 200 at specified temperatures and composts at predetermined temperatures and humidities. Thus, the bags 200 and films 300 described herein are compostable and capable of sealing a perishable material within the bag 200.

Referring now to FIG. 3, the film 300 may include the third outer layers 166, the first outer layer system 302, the core layer system 304, and the second outer layer system 306 coextruded and laminated to form the film 300. The first outer layer system 302, the core layer system 304, and the second outer layer system 306 are coextruded as described herein and at least partially seal the perishable material in the bag 200. The outer layer 166 may include any substrate necessary to modify or tune the physical properties of the film 300. For example, the outer layer 166 may include any material that may add strength, stiffness, heat resistance, durability and/or printability to the film 300. Further, the outer layer 166 may act to prevent the migration of certain types of molecules, such as, for example, moisture and/or oxygen, from penetrating into the first outer layer system 302, the core layer system 304, and the second outer layer system 306 of the film 300. Further, the outer layer 166 may add flex crack resistance to the film 300. In addition, the outer layer 166 may be composed of a material that may act as a sealant when heated. However, it should be noted that the outer layer 166 may be composed of any material that enables the film 300 to operate as described herein. Additionally, in some embodiments, the film 300 may not include the third outer layers 166.

As shown in FIG. 3, the first outer layer system 302, the core layer system 304, and the second outer layer system 306 each include a plurality of layers within the first outer layer system 302, the core layer system 304, and the second outer layer system 306. Specifically, in the illustrated embodiment, the first outer layer system 302, the core layer system 304, and the second outer layer system 306 each include three layers. In alternative embodiments, the first outer layer system 302, the core layer system 304, and the second outer layer system 306 may each include any number of layers that enable the film 300 to operate as described herein, including, without limitation, a single layer, two layers, four layers, or more than four layers. In the illustrated embodiment, the first outer layer system 302 includes a first layer 308, a second layer 310, and a third layer 312; the core layer system 304 includes a fourth layer 314, a fifth layer 316, and a sixth layer 318; and the second outer layer system 306 includes a seventh layer 320, an eighth layer 322, and a ninth layer 324.

In the illustrated embodiment, the first outer layer system 302 includes the first layer 308, the second layer 310, and the third layer 312 each formed from compostable materials; the core layer system 304 includes the fourth layer 314, the fifth layer 316, and the sixth layer 318 each formed from compostable materials; and the second outer layer system 306 includes the seventh layer 320, the eighth layer 322, and the ninth layer 324 each formed from compostable materials. The film 300 is formed by extruding the first melt stream 142 into the first layer 308, extruding the second melt stream 144 into the second layer 310, extruding the third melt stream 146 into the third layer 312, extruding the fourth melt stream 148 into the fourth layer 314, extruding the fifth melt stream 150 into the fifth layer 316, extruding the sixth melt stream 152 into the sixth layer 318, extruding the seventh melt stream 154 into the seventh layer 320, extruding the eighth melt stream 156 into the eighth layer 322, and extruding the ninth melt stream 158 into the ninth layer 324. Each of the materials 122 are formed of a compostable material such that the bag 200 is compostable.

Specifically, the first outer layer system 302 includes the first layer 308, the second layer 310, and the third layer 312 each formed from a thermoplastic bio-resin configured to at least partially seal the perishable material from the migration of molecules such as, for example, oxygen and water vapor, thereby protecting the perishable materials contained within packages made from the film 300. For example, each of the first layer 308, the second layer 310, and the third layer 312 are formed from the same starch polymer, plasticizer free thermoplastic bio-resin. More specifically, each of the first layer 308, the second layer 310, and the third layer 312 are formed from the same thermoplastic bio-resin, BIOPLAST GF106/02® from BIOTEC®. In alternative embodiments, the first layer 308, the second layer 310, and the third layer 312 may be composed of any thermoplastic bio-resin or any material that may prevent the migration of molecules such as, for example, oxygen and water vapor, thereby protecting the perishable materials contained within packages made from the film 300. BIOPLAST GF106/02® from BIOTEC® is a plasticizer-free and GMO-free thermoplastic material that contains natural potato starch. It is suitable for processing by blown film extrusion to produce items that are completely biodegradable. The absence of plasticizer allows BIOPLAST GF 106/02 to be easily processed to manufacture stable products of consistent quality. The material has an excellent shelf life but will biodegrade readily in an industrial composting environment. Additionally, BIOPLAST GF106/02® has an oxygen permeability (80 μm) of about 750 cm³/(m² d bar) according to test method DIN 53 380-3 and has a water vapor permeability (80 μm) of about 120 g/(m2 d) according to test method DIN 53 122-1.

Additionally, the second outer layer system 306 includes the seventh layer 320, the eighth layer 322, and the ninth layer 324 each formed from a thermoplastic bio-resin configured to at least partially seal the perishable material from the migration of molecules such as, for example, oxygen and water vapor, thereby protecting the perishable materials contained within packages made from the film 300. For example, each of the seventh layer 320, the eighth layer 322, and the ninth layer 324 are formed from the same starch polymer, plasticizer free thermoplastic bio-resin. More specifically, each of the seventh layer 320, the eighth layer 322, and the ninth layer 324 are formed from the same thermoplastic bio-resin, BIOPLAST GF106/02® from BIOTEC®. In alternative embodiments, the seventh layer 320, the eighth layer 322, and the ninth layer 324 may be composed of any thermoplastic bio-resin or any material that may prevent the migration of molecules such as, for example, oxygen and water vapor, thereby protecting the perishable materials contained within packages made from the film 300. BIOPLAST GF106/02° from BIOTEC® is a plasticizer-free and GMO-free thermoplastic material that contains natural potato starch. It is suitable for processing by blown film extrusion to produce items that are completely biodegradable. The absence of plasticizer allows BIOPLAST GF 106/02 to be easily processed to manufacture stable products of consistent quality. The material has an excellent shelf life but will biodegrade readily in an industrial composting environment. Additionally, BIOPLAST GF106/02° has an oxygen permeability (80 μm) of about 750 cm³/(m² d bar) according to test method DIN 53 380-3 and has a water vapor permeability (80 μm) of about 120 g/(m2 d) according to test method DIN 53 122-1.

The layers of the first outer layer system 302 and the second outer layer system 306 may be more resistant to water vapor permeation than to oxygen permeation. Specifically, as described above, the oxygen permeability of the first outer layer system 302 and the second outer layer system 306 is about 750 cm³/(m² d bar) while the water vapor permeability of the first outer layer system 302 and the second outer layer system 306 is about 120 g/(m2 d). Thus, the first outer layer system 302 and the second outer layer system 306 may be primarily configured to protect the core layer system 304 and the perishable material with the bag 200 from water vapor and the core layer system 304 is primarily configured to protect the perishable material within the bag 200 from oxygen.

The core layer system 304 may be primarily configured to protect the perishable material with the bag 200 from oxygen permeation into the bag 200. Specifically, the core layer system 304 includes the fifth layer 316 configured to protect the perishable material with the bag 200 from oxygen permeation into the bag 200. In the illustrated embodiment, the fifth layer 316 is formed from at least one of a Polyvinyl Alcohol (PVOH) and a modified PVOH. Specifically, in the illustrated embodiment, the fifth layer 316 is formed from a Butendiol Vinyl Alcohol co-Polymer (BVOH). More specifically, in the illustrated embodiment, the fifth layer 316 is formed from Nichigo G-Polymer BVE 8049P® from Mitsubishi Chemical Corp.®. BVOHs (Nichigo G-Polymer BVE 8049P®) are water soluble and have increased resistance to oxygen permeation than typical PVOHs. Specifically, Nichigo G-Polymer BVE 8049P® has increased hydrogen coupling and, as such, it has increased resistance to oxygen permeation than typical PVOHs. More specifically, Nichigo G-Polymer BVE 8049P® has an oxygen permeability of about 0.0023 (cc 20 μm/m² day atm) and it dissolves in water at warm temperatures. Accordingly, the fifth layer 316 enables the film 300 to protect perishable materials within the bag 200 while also enabling the bag 200 to compost when the bag 200 is exposed to water at warm temperatures (compost conditions).

Additionally, in the illustrated embodiment, the fourth layer 314 and the sixth layer 318 are tie layers attached to the fifth layer 316 and the first and second outer layer systems 302 and 306. A “tie layer” is defined as an internal layer that provides adhesion or bonding to two layers of a coextruded structure and is typically disposed adjacent to and between the two layers of the coextruded structure. The fourth layer 314 and the sixth layer 318 are tie layers attached to the fifth layer 316 and the first and second outer layer systems 302 and 306. Specifically, the fourth layer 314 is a tie layer configured to adhere and bond the fifth layer 316 to the third layer 312 of the first outer layer system 302 and the sixth layer 318 is a tie layer configured to adhere and bond the fifth layer 316 to the third layer 312 of the second outer layer system 306. The fourth layer 314 and the sixth layer 318 may include modified polyolefins, such as maleic anhydride modified polyolefins. Polyolefins useful as the fourth layer 314 and the sixth layer 318 of the film 300 include, but are not limited to, anhydride modified linear low density polyethylene or any other maleic anhydride modified polyolefin polymer or copolymer, such as anhydride modified ethylene-vinyl acetate copolymer and/or anhydride modified ethylene methyl acrylate copolymer. Alternatively, the fourth layer 314 and the sixth layer 318 may include a material that is not typically utilized as a tie resin. Specifically, the fourth layer 314 and the sixth layer 318 may include materials that are not modified with maleic anhydride, such as ethylene vinyl acetate copolymer and ethylene methyl acrylate copolymer. Other polymeric materials that may be useful as tie layers include, but are not limited to, acid terpolymer comprising ethylene, acrylic acid and methyl acrylate, polyamide, and polystyrene block copolymers. In addition, the fourth layer 314 and the sixth layer 318 may include blends of tie resins with other polymeric material, such as polyolefins or the like. In the illustrated embodiment, the fourth layer 314 and the sixth layer 318 are formed from Nichigo G-Polymer Biodegradable Resin BTR8002P® from Mitsubishi Chemical Corp.®.

The materials and structure of the film 300 is configured to enable the bag 200 to protect and preserve perishable materials within the bag 200 at a first temperature and/or humidity range and to enable the bag 200 to compost a second temperature and/or humidity range. Specifically, the first outer layer system 302 and the second outer layer system 306 each have greater resistance to water vapor permeation than oxygen permeation while the core layer system 304 has a greater resistance to oxygen permeation than water vapor permeation. Additionally, the first outer layer system 302 and the second outer layer system 306 are positioned on opposite sides of the core layer system 304 such that the first outer layer system 302 and the second outer layer system 306 protect the core layer system 304 from water vapor. The fifth layer 316 of the core layer system 304 is water soluble such that the fifth layer 316 of the core layer system 304 dissolves in water. Thus, the first outer layer system 302 and the second outer layer system 306 protect the fifth layer 316 from dissolution due to water vapor. Additionally, the fifth layer 316 is a barrier layer that resists permeation of oxygen into the bag 200. Thus, the first outer layer system 302 and the second outer layer system 306 protect the fifth layer 316 and the perishable materials within the bag 200 from water vapor permeation and the fifth layer 316 protects the perishable materials within the bag 200 from oxygen permeation into the bag 200. Accordingly, the materials and structure of the film 300 is configured to enable the bag 200 to protect and preserve perishable materials within the bag 200.

However, because the materials 122 are compostable, the materials and structure of the film 300 is configured to enable the bag 200 to protect and preserve perishable materials within the bag 200 over the first temperature and/or humidity range. Specifically, in the illustrated embodiment, the materials and structure of the film 300 is configured to enable the bag 200 to protect and preserve perishable materials within the bag 200 in cool, dry conditions. More specifically, in the illustrated embodiment, the materials and structure of the film 300 is configured to enable the bag 200 to protect and preserve perishable materials within the bag 200 in refrigerator conditions. In the illustrated embodiment, the materials and structure of the film 300 is configured to enable the bag 200 to protect and preserve perishable materials within the bag 200 in a first temperature range of about 32° F. to about 40° F. and a first relative humidity range of about 50% to about 80%. The first temperature and/or humidity range listed above enables the materials and structure of the film 300 to remain intact such that the film protects the perishable material within the bag 200 from water vapor and oxygen.

When the temperature and humidity of the environment that the bag 200 is within is raised to a second temperature and/or humidity range, the bag 200 and the film 300 composts and dissolves. Specifically, when the temperature and humidity of the environment that the bag 200 is within is raised above the first temperature and/or humidity range, the bag 200 and the film 300 composts and dissolves. In the illustrated embodiment, the second temperature range is above about 40° F. and the second humidity range is above 70%. The second temperature and/or humidity range listed above enables the first and second outer layer systems 302 and 306 to break down, exposing the core layer system 304 to water vapor from the environment. The water vapor from the environment then dissolves the core layer system 304 such that the bag 200 and film 300 dissolve and are compostable within the second temperature and/or humidity range. Accordingly, as described herein, the materials and the structure of the film 300 enables the film 300 and the bag 200 to protect perishable materials within the first temperature and/or humidity range while also enabling the film 300 and the bag 200 to be compostable within the second temperature and/or humidity range.

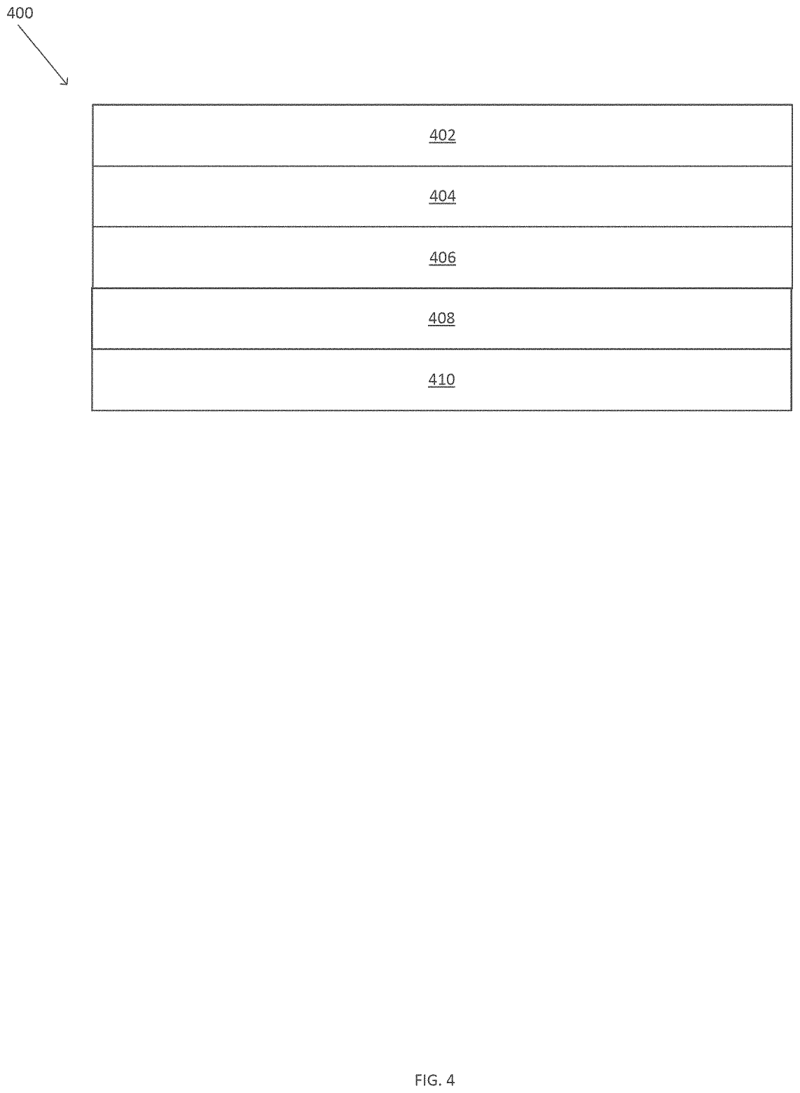

FIG. 4 illustrates an alternative film 400 including a first layer 402, a second layer 404, a third layer 406, a fourth layer 408, and a fifth layer 410 coextruded and laminated to form the film 400. The first layer 402, the second layer 404, the third layer 406, the fourth layer 408, and the fifth layer 410 are coextruded as described herein and at least partially seal the perishable material in the bag 200. In the illustrated embodiment, the first layer 402, the second layer 404, the third layer 406, the fourth layer 408, and the fifth layer 410 are each formed from compostable materials. The system 100 described above is modified to manufacture the film 400. Specifically, the film 400 is formed by extruding the first melt stream 142 into the first layer 402, extruding the second melt stream 144 into the second layer 404, extruding the third melt stream 146 into the third layer 406, extruding the fourth melt stream 148 into the fourth layer 408, and extruding the fifth melt stream 150 into the fifth layer 410. Additionally one or more of the extruders 102 may be configured to extrude an additional material into any of the first layer 402, the second layer 404, the third layer 406, the fourth layer 408, and the fifth layer 410. Each of the materials 122 are formed of a compostable material such that the bag 200 is compostable.

Specifically, the first layer 402 is formed from a thermoplastic bio-resin configured to at least partially seal the perishable material from the migration of molecules such as, for example, oxygen and water vapor, thereby protecting the perishable materials contained within packages made from the film 400. For example, the first layer 402 is formed from a starch polymer, plasticizer free thermoplastic bio-resin. More specifically, the first layer 402 is formed from the thermoplastic bio-resin, BIOME DP301® from BIOTEC®. In alternative embodiments, the first layer 402 may be composed of any thermoplastic bio-resin or any material that may prevent the migration of molecules such as, for example, oxygen and water vapor, thereby protecting the perishable materials contained within packages made from the film 400. BIOME DP301® from BIOTEC® is a plasticizer-free and GMO-free thermoplastic material that contains natural potato starch. It is suitable for processing by blown film extrusion to produce items that are completely biodegradable. The absence of plasticizer allows BIOME DP301® to be easily processed to manufacture stable products of consistent quality. The material has an excellent shelf life but will biodegrade readily in an industrial composting environment.

Additionally, the first layer 402 may further include an additive or slip agent that reduces surface friction of the first layer 402 during extrusion and reduces water vapor permeability of the first layer 402. As used herein, the term additive or agent means a substance added to a film or layer of the film in small quantities to improve or preserve the layer or film. In the illustrated embodiment, the first layer 402 includes an additive or slip agent that is formed of aliphaticaromatic copolyester based on the monomers 1.4-butanediol, adipic acid and terephthalic acid. More specifically, the additive or slip agent is formed from the biodegradable bio-resin, Ecoflex® Batch SL05® from BASF®. In alternative embodiments, the additive or slip agent may be composed of any thermoplastic bio-resin or any material that may prevent the migration of molecules such as, for example, oxygen and water vapor, thereby protecting the perishable materials contained within packages made from the film 400. Ecoflex® Batch SL05® from BASF® is a plasticizer-free thermoplastic material that contains polylactic acid (PLA). It is suitable for processing by blown film extrusion to produce items that are completely biodegradable. The absence of plasticizer allows Ecoflex® Batch SL05® to be easily processed to manufacture stable products of consistent quality. The material has an excellent shelf life but will biodegrade readily in an industrial composting environment. In the illustrated embodiment, the first layer 402 includes 99% BIOME DP301® from BIOTEC® and 1% Ecoflex® Batch SL05® from BASF®. In alternative embodiments, the first layer 402 may include any amount of BIOME DP301 from BIOTEC® and Ecoflex® Batch SL05® from BASF® that enables the film 400 to operate as described herein.

Additionally, in the illustrated embodiment, the second layer 404 and the fourth layer 408 are tie layers attached to the third layer 406 and the first and fifth layers 402 and 410. A “tie layer” is defined as an internal layer that provides adhesion or bonding to two layers of a coextruded structure and is typically disposed adjacent to and between the two layers of the coextruded structure. The second layer 404 and the fourth layer 408 are tie layers attached to the third layer 406 and the first and fifth layers 402 and 410. Specifically, the second layer 404 is a tie layer configured to adhere and bond the first layer 402 to the third layer 406 and the fourth layer 408 is a tie layer configured to adhere and bond the fifth layer 410 to the third layer 406. The second layer 404 and the fourth layer 408 may include modified polyolefins, such as maleic anhydride modified polyolefins. Polyolefins useful as the second layer 404 and the fourth layer 408 of the film 400 include, but are not limited to, anhydride modified linear low density polyethylene or any other maleic anhydride modified polyolefin polymer or copolymer, such as anhydride modified ethylene-vinyl acetate copolymer and/or anhydride modified ethylene methyl acrylate copolymer. Alternatively, the second layer 404 and the fourth layer 408 may include a material that is not typically utilized as a tie resin. Specifically, the second layer 404 and the fourth layer 408 may include materials that are not modified with maleic anhydride, such as ethylene vinyl acetate copolymer and ethylene methyl acrylate copolymer. Other polymeric materials that may be useful as tie layers include, but are not limited to, acid terpolymer comprising ethylene, acrylic acid and methyl acrylate, polyamide, and polystyrene block copolymers. In addition, the second layer 404 and the fourth layer 408 may include blends of tie resins with other polymeric material, such as polyolefins or the like. In the illustrated embodiment, the second layer 404 and the fourth layer 408 are formed from BIOME DP660® from BIOTEC®.

The third layer 406 may be primarily configured to protect the perishable material with the bag 200 from oxygen permeation into the bag 200. In the illustrated embodiment, the third layer 406 is formed from at least one of a Polyvinyl Alcohol (PVOH) and a modified PVOH. Specifically, in the illustrated embodiment, the third layer 406 is formed from a modified co-polymer based on vinyl acetate hydrolyzed monomers. More specifically, in the illustrated embodiment, the third layer 406 is formed from Hydropol 33103® from Aquapak®. Hydropol 33103® is water soluble and has increased resistance to oxygen permeation than typical PVOHs. Specifically, Hydropol 33103® has increased hydrogen coupling and, as such, it has increased resistance to oxygen permeation than typical PVOHs. More specifically, Hydropol 33103® has an oxygen permeability of about 0.0581 (cc/m²/day) and it dissolves in water at warm temperatures. Accordingly, the third layer 406 enables the film 400 to protect perishable materials within the bag 200 while also enabling the bag 200 to compost when the bag 200 is exposed to water at warm temperatures (compost conditions).

The fifth layer 410 is formed from a thermoplastic bio-resin configured to at least partially seal the perishable material from the migration of molecules such as, for example, oxygen and water vapor, thereby protecting the perishable materials contained within packages made from the film 400. For example, the fifth layer 410 is formed from a starch polymer, plasticizer free thermoplastic bio-resin. More specifically, the fifth layer 410 is formed from the thermoplastic bio-resin, BIOME DP300v2® from BIOTEC®. In alternative embodiments, the fifth layer 410 may be composed of any thermoplastic bio-resin or any material that may prevent the migration of molecules such as, for example, oxygen and water vapor, thereby protecting the perishable materials contained within packages made from the film 400. BIOME DP DP300v2® from BIOTEC® is a plasticizer-free and GMO-free thermoplastic material that contains natural potato starch. It is suitable for processing by blown film extrusion to produce items that are completely biodegradable. The absence of plasticizer allows BIOME DP DP300v2® to be easily processed to manufacture stable products of consistent quality. The material has an excellent shelf life but will biodegrade readily in an industrial composting environment.

Additionally, the fifth layer 410 may optionally include an additive or agent that colors the fifth layer 410 and the film 400 white. As used herein, the term additive or agent means a substance added to a film or layer of the film in small quantities to improve or preserve the layer or film. In the illustrated embodiment, the fifth layer 410 includes an additive or slip agent that is formed of Polybutylene Adipate Terphthalate (PBAT) including titanium dioxide. More specifically, the additive or slip agent is formed from TA31-20 MB01® from SUKANO®. In alternative embodiments, the additive or slip agent may be composed of any material that may prevent the migration of molecules such as, for example, oxygen and water vapor, thereby protecting the perishable materials contained within packages made from the film 400. TA31-20 MB01® from SUKANO® includes 60% PBAT and 40% titanium dioxide. It is suitable for processing by blown film extrusion to produce items that are completely biodegradable. The absence of plasticizer allows TA31-20 MB01® to be easily processed to manufacture stable products of consistent quality. The material has an excellent shelf life but will biodegrade readily in an industrial composting environment. In the illustrated embodiment, the fifth layer 410 includes 90% BIOME DP300v2® from BIOTEC® and 10% TA31-20 MB01® from SUKANO®. In alternative embodiments, the fifth layer 410 may include any amount of BIOME DP300v2® from BIOTEC® and TA31-20 MB01® from SUKANO® that enables the film 400 to operate as described herein.

The materials and structure of the film 400 is configured to enable the bag 200 to protect and preserve perishable materials within the bag 200 at a first temperature and/or humidity range and to enable the bag 200 to compost a second temperature and/or humidity range. Specifically, the first layer 402 and the fifth layer 410 each may have greater resistance to water vapor permeation than oxygen permeation while the third layer 406 may have a greater resistance to oxygen permeation than water vapor permeation. Additionally, the first layer 402 and the third layer 406 are positioned on opposite sides of the second layer 404 such that the first layer 402 and the fifth layer 410 protect the third layer 406 from water vapor. The third layer 406 is water soluble such that the third layer 406 dissolves in water. Thus, the first layer 402 and the fifth layer 410 protect the third layer 406 from dissolution due to water vapor. Additionally, the third layer 406 is a barrier layer that resists permeation of oxygen into the bag 200. Thus, the first layer 402 and the fifth layer 410 protect the third layer 406 and the perishable materials within the bag 200 from water vapor permeation and the third layer 406 protects the perishable materials within the bag 200 from oxygen permeation into the bag 200. Accordingly, the materials and structure of the film 400 is configured to enable the bag 200 to protect and preserve perishable materials within the bag 200.

However, because the materials 122 are compostable, the materials and structure of the film 400 is configured to enable the bag 200 to protect and preserve perishable materials within the bag 200 over the first temperature and/or humidity range. Specifically, in the illustrated embodiment, the materials and structure of the film 400 is configured to enable the bag 200 to protect and preserve perishable materials within the bag 200 in cool, dry conditions. More specifically, in the illustrated embodiment, the materials and structure of the film 400 is configured to enable the bag 200 to protect and preserve perishable materials within the bag 200 in refrigerator conditions. In the illustrated embodiment, the materials and structure of the film 400 is configured to enable the bag 200 to protect and preserve perishable materials within the bag 200 in a first temperature range of about 32° F. to about 40° F. and a first relative humidity range of about 50% to about 80%. The first temperature and/or humidity range listed above enables the materials and structure of the film 400 to remain intact such that the film protects the perishable material within the bag 200 from water vapor and oxygen.

When the temperature and humidity of the environment that the bag 200 is within is raised to a second temperature and/or humidity range, the bag 200 and the film 400 composts and dissolves. Specifically, when the temperature and humidity of the environment that the bag 200 is within is raised above the first temperature and/or humidity range, the bag 200 and the film 400 composts and dissolves. In the illustrated embodiment, the second temperature range is above about 40° F. and the second humidity range is above 70%. The second temperature and/or humidity range listed above enables the first and second outer layer systems 302 and 306 to break down, exposing the second layer 404 to water vapor from the environment. The water vapor from the environment then dissolves the second layer 404 such that the bag 200 and film 400 dissolve and are compostable within the second temperature and/or humidity range. Accordingly, as described herein, the materials and the structure of the film 400 enables the film 400 and the bag 200 to protect perishable materials within the first temperature and/or humidity range while also enabling the film 400 and the bag 200 to be compostable within the second temperature and/or humidity range.

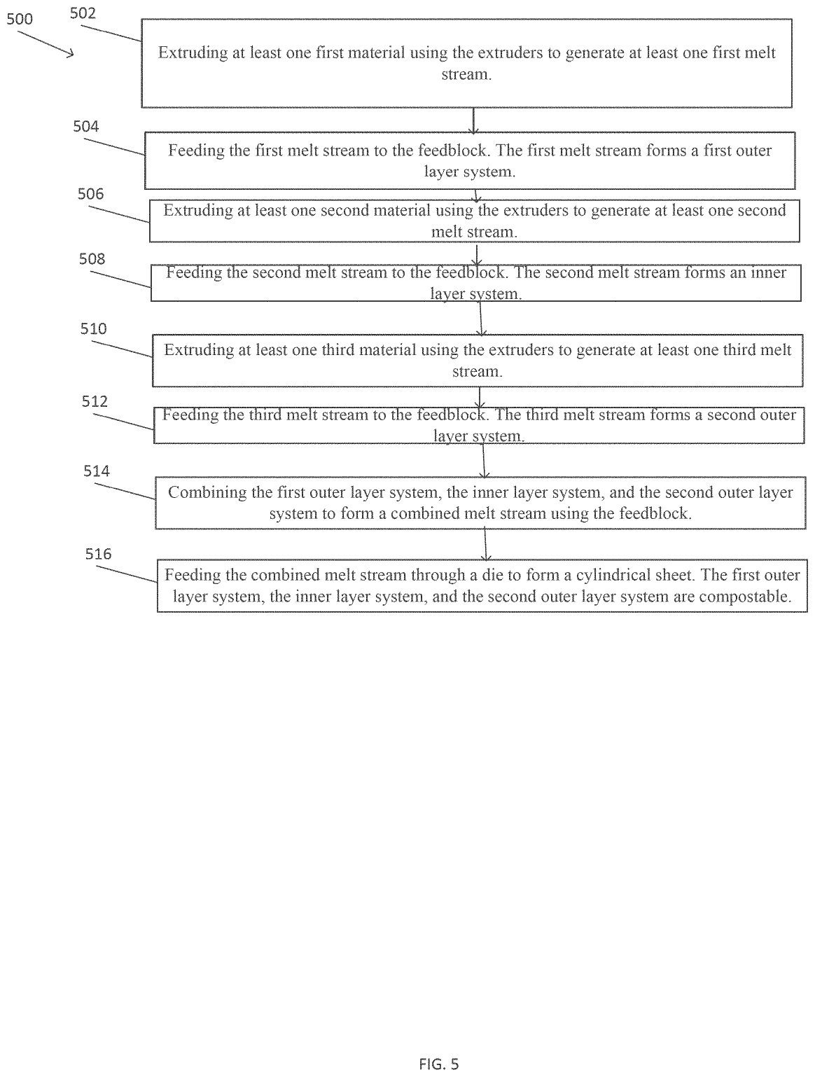

FIG. 5 is a flow diagram illustrating an example method 500 of manufacturing a film structure with an extrusion system. The extrusion system includes a plurality of extruders, a feedblock, and a die. The method 500 includes extruding 502 at least one first material using the extruders to generate at least one first melt stream. The method 500 also includes feeding 504 the first melt stream to the feedblock. The first melt stream forms a first outer layer system. The method 500 further includes extruding 506 at least one second material using the extruders to generate at least one second melt stream. The method 500 also includes feeding 508 the second melt stream to the feedblock. The second melt stream forms a core layer system. The method 500 further includes extruding 510 at least one third material using the extruders to generate at least one third melt stream. The method 500 also includes feeding 512 the third melt stream to the feedblock. The third melt stream forms a second outer layer system. The method 500 further includes combining 514 the first outer layer system, the core layer system, and the second outer layer system to form a combined melt stream using the feedblock. The method 500 also includes feeding 516 the combined melt stream through a die to form a cylindrical sheet. The first outer layer system, the core layer system, and the second outer layer system are compostable.

### EXAMPLES

Film 300 was manufactured as described herein and formed into two sets of bags 200 as described herein. The first set of bags 200 (Sample Set A) includes films 300 including a 6/12/6 core and the second set of bags 200 (Sample Set B) includes films 300 including a 5/5/5 core. A plurality of tests were conducted on the Sample Sets A and B as described below.

### Example 1—Compost Test

A three samples of Sample Set A (A1, A2, A3) and three samples of Sample Set B (B1, B2, B3) were subjected to a compost test in a composting lab. Specifically, the samples listed above were subjected to compost conditions (conditions within the second temperature and/or humidity range). As shown in Table 1, all of the samples 100% disintegrated to ISO 17025 standards within 49 days during the compost test. Accordingly, as described herein, the materials and the structure of the film 300 enables the film 300 and the bag 200 to protect perishable materials within the first temperature and/or humidity range while also enabling the film 300 and the bag 200 to be compostable within the second temperature and/or humidity range. The compost test was run in a compost batch that had 54.12% moisture, 75.69% ash, a pH of 9.193, 119000 mg/kg of Total Organic Carbon, 11900 mg/kg of Total Organic Nitrogen, a carbon to nitrogen ratio of 10, and 26.6% wt/wt to Total Organic Matter.

TABLE 1
Results of Compost Test

| | Test Sample | Final Test | |
|---|---|---|---|
| Sample | Weight | Sample Weight | % |
| Reference | (grams) | (grams) | Disintegration |
| A1 | 5.22 | 0.00 | 100.00 |
| A2 | 5.18 | 0.00 | 100.00 |
| A3 | 5.21 | 0.00 | 100.00 |
| B1 | 5.21 | 0.00 | 100.00 |
| B2 | 5.18 | 0.00 | 100.00 |
| B3 | 5.18 | 0.00 | 100.00 |

### Example 2—Preservation Test

A preservation test was conducted to measure bags 200 ability to preserve perishable goods with a Sample A Bag and a Sample B Bag. The Sample A Bag contained a first perishable material, a first pork loin, and the Sample B Bag contained a second perishable material, a second pork loin. Both bags were vacuum sealed and the Sample A Bag was treated with a shrink tunnel and the Sample B Bag was not. Both bags were stored in refrigerated conditions as described herein (within the first temperature and/or humidity range). Both bags sealed and protected the first and second perishable materials for greater than 90 days. Accordingly, as described herein, the materials and the structure of the film 300 enables the film 300 and the bag 200 to protect perishable materials within the first temperature and/or humidity range while also enabling the film 300 and the bag 200 to be compostable within the second temperature and/or humidity range.

### Example 3—Impact Test

An impact test was conducted on a Sample A Film and on a Sample B Film. The impact test was conducted with an impact test apparatus having a total mass of 5.65 kg dropped from an impact height of 458.00 mm with an impact velocity of 3.00 m/s and an impact energy of 25.35 J. Both Sample Films broke on impact.

### Example 4—General Tests and Measurements

General tests and measurements were conducted on a plurality of Sample A Films and on a plurality of Sample B Films. The first measurement was a thickness measurement and Table 2 shows the results of the measurements.

TABLE 2
Results of Caliper Measurements
CALIPER, MILS

| Measurement # | A | B |
|---|---|---|
| 1 | 2.62 | 2.58 |
| 2 | 5.47 | 2.49 |
| 3 | 5.80 | 3.82 |
| 4 | 4.58 | 1.89 |
| 5 | 3.70 | 2.38 |
| 6 | 2.61 | 1.92 |
| 7 | 3.74 | 1.56 |
| 8 | 3.13 | 2.14 |
| 9 | 3.29 | 2.14 |
| 10 | 2.83 | 2.26 |
| Avg | 3.78 | 2.32 |
| StDev | 1.15 | 0.61 |

The second measurement was a stiffness measurement and Table 3 shows the results of the measurements.

TABLE 3
Results of Stiffness Measurements
STIFFNESS (LOOP), 5″/min, GRAMS

| | |
|---|---|
| A | B |

| Measurement # | MD | CMD | MD | CMD |
|---|---|---|---|---|
| 1 | 6.2 | 7.0 | 3.8 | 3.0 |
| 2 | 6.7 | 7.4 | 2.8 | 2.2 |
| 3 | 6.2 | 6.1 | 4.7 | 2.3 |
| 4 | 6.4 | 4.6 | 2.6 | 2.3 |
| 5 | 6.2 | 4.6 | 2.8 | 2.8 |
| Avg | 6.3 | 5.9 | 3.3 | 2.5 |
| StDev | 0.219 | 1.311 | 0.893 | 0.356 |

The third measurement was a haze and clarity measurement and Table 4 shows the results of the measurements.

TABLE 4
Results of Haze and Clarity Measurements

| | |
|---|---|
| HAZE, % | CLARITY, % |

| Measurement # | A | B | A | B |
|---|---|---|---|---|
| 1 | 90.6 | 94.5 | 7.2 | 6.8 |
| 2 | 90.6 | 94.1 | 8.2 | 6.7 |
| 3 | 90.2 | 94.4 | 8.0 | 6.5 |
| 4 | 91.7 | 94.4 | 8.8 | 6.9 |
| 5 | 89.0 | 94.4 | 9.1 | 6.8 |
| Avg | 90.4 | 94.4 | 8.3 | 6.7 |
| StDev | 0.97 | 0.15 | 0.74 | 0.15 |

The fourth measurement was an elasticity measurement and Table 5 shows the results of the measurements.

TABLE 5
Results of Elasticity Measurements
SECANT MODULUS, 1″/min; PSI

| | A | | | | B | | | |
|---|---|---|---|---|---|---|---|---|
| | MD | | CMD | | MD | | CMD | |
| | span: | 5″ | span: | 5″ | span: | 5″ | span: | 5″ |
| | 1% Secant | | 1% Secant | | 1% Secant | | 1% Secant | |
| Measurement | Load | Modulus | Load | Modulus | Load | Modulus | Load | Modulus |
| # | lbf | psi | lbf | psi | lbf | psi | lbf | psi |
| 1 | 2.64 | 58454 | 1.53 | 25918 | 1.13 | 58731 | 1.14 | 54501 |
| 2 | 2.43 | 51779 | 1.15 | 25073 | 1.65 | 75526 | 1.21 | 52408 |
| 3 | 2.40 | 44725 | 1.49 | 47988 | 1.87 | 65465 | 0.90 | 45937 |
| 4 | 3.39 | 85972 | 0.81 | 14947 | 1.28 | 66132 | 0.76 | 28696 |
| 5 | 3.25 | 98307 | 0.88 | 37738 | 0.91 | 46386 | 1.24 | 56384 |
| Avg | 2.82 | 67847 | 1.17 | 30333 | 1.37 | 62448 | 1.05 | 47585 |
| StDev | 0.47 | 23116 | 0.33 | 12752 | 0.39 | 10788 | 0.21 | 11270 |
| Min | 2.40 | 44725 | 0.81 | 14947 | 0.91 | 46386 | 0.76 | 28696 |
| Max | 3.39 | 98307 | 1.53 | 47988 | 1.87 | 75526 | 1.24 | 56384 |
| Range | 0.99 | 53582 | 0.72 | 33041 | 0.96 | 29140 | 0.48 | 27688 |

The fifth measurement was a weight measurement and Table 6 shows the results of the measurements.

TABLE 6
Results of Weight Measurements
BASIS WEIGHT, lbs/3000 ft²

| | A | | B | |
|---|---|---|---|---|
| | template: | 4 × 4″ | template: | 4 × 4″ |
| | factor: | 59.5 | factor: | 59.5 |
| Measurement # | Grams | lbs/ream | Grams | lbs/ream |
| 1 | 0.710 | 42.245 | 0.705 | 41.948 |
| 2 | 0.743 | 44.209 | 0.652 | 38.794 |
| 3 | 0.750 | 44.625 | 0.746 | 44.387 |
| 4 | 0.708 | 42.126 | 0.590 | 35.105 |
| 5 | 0.818 | 48.671 | 0.618 | 36.771 |
| Avg | | 44.375 | | 39.401 |
| StDev | | 2.65 | | 3.778 |

The sixth measurement was a tensile strength measurement and Tables 7 and 8 shows the results of the measurements.

TABLE 7
Results of Tensile Strength Measurements for Sample A
TENSILE STRENGTH, PSI

| | | | 4″ | | | | | | | 4″ | | | | |
|---|---|---|---|---|---|---|---|---|---|---|---|---|---|---|
| | | | Span, | | | | | | | Span, | | | | |
| | | | 2″/min | | | | | | | 2″/min | | | | |
| | | test | crosshead | | | | | | test | crosshead | | | | |
| | | conditions: | speed | | | | | | conditions: | speed | | | | |
| | MD | | | | | | | CMD | | | | | | |
| | Load | Tensile | Elong. | | Load | Tensile | | Load | Tensile | Elong. | | Load | Tensile | |
| Mea- | @ | @ | at | | @ | @ | Max | @ | @ | at | | @ | @ | Max |
| surement | Break | Break | Break | TEA | Yield | Yield | Load | Break | Break | Break | TEA | Yield | Yield | Load |
| # | (lbf) | (psi) | (%) | (lb/in) | (lbf) | (psi) | (lbf) | (lbf) | (psi) | (%) | (lb/in) | (lbf) | (psi) | (lbf) |
| 1 | 2.4 | 458 | 9.3 | 0.48 | 6.2 | 1187 | 6.2 | 1.9 | 625 | 12.3 | 0.23 | 2.0 | 660 | 2.0 |
| 2 | 2.6 | 1284 | 40.6 | 0.98 | 2.6 | 1269 | 2.7 | 3.8 | 1259 | 3.6 | 0.10 | — | — | 3.8 |
| 3 | 4.2 | 1032 | 29.2 | 1.19 | 4.5 | 1092 | 4.5 | 1.1 | 303 | 4.7 | 0.08 | 2.1 | 576 | 2.1 |
| 4 | 6.0 | 2627 | 63.8 | 3.53 | — | — | 6.1 | 3.3 | 1475 | 33.7 | 1.12 | 3.7 | 1628 | 3.7 |
| 5 | 6.0 | 2113 | 68.3 | 4.59 | 6.6 | 2314 | 7.3 | 1.2 | 369 | 3.3 | 0.05 | — | — | 1.9 |
| Avg | 4.2 | 1503 | 42.2 | 2.15 | 5.0 | 1466 | 5.4 | 2.3 | 806 | 11.5 | 0.32 | 2.6 | 955 | 2.7 |
| StDev | 1.75 | 866 | 24.50 | 1.80 | 1.83 | 570 | 1.79 | 1.23 | 531 | 12.94 | 0.45 | 0.95 | 585 | 0.96 |

TABLE 8
Results of Tensile Strength Measurements for Sample B
TENSILE STRENGTH, PSI

| | | | 4″ | | | | | | | 2″ | | | | |
|---|---|---|---|---|---|---|---|---|---|---|---|---|---|---|
| | | | Span, | | | | | | | Span, | | | | |
| | | | 2″/min | | | | | | | 20″/minute | | | | |
| | | test | crosshead | | | | | | test | crosshead | | | | |
| | | conditions: | speed | | | | | | conditions: | speed | | | | |
| | MD | | | | | | | CMD | | | | | | |
| | Load | Tensile | Elong. | | Load | Tensile | | Load | Tensile | Elong. | | Load | Tensile | |
| Mea- | @ | @ | at | | @ | @ | Max | @ | @ | at | | @ | @ | Max |
| surement | Break | Break | Break | TEA | Yield | Yield | Load | Break | Break | Break | TEA | Yield | Yield | Load |
| # | (lbf) | (psi) | (%) | (lb/in) | (lbf) | (psi) | (lbf) | (lbf) | (psi) | (%) | (lb/in) | (lbf) | (psi) | (lbf) |
| 1 | 5.1 | 2494 | 126.1 | 5.63 | — | — | 5.1 | 4.2 | 1990.0 | 180.9 | 6.6 | 3.8 | 1811 | 4.2 |
| 2 | 5.8 | 2659 | 211.6 | 10.27 | 5.0 | 2283 | 5.8 | 3.8 | 2210.0 | 279.2 | 9.57 | 3.6 | 2091 | 3.9 |
| 3 | 4.6 | 2686 | 169.0 | 6.50 | — | — | 4.6 | 4.7 | 2218 | 266.7 | 11.26 | 4.4 | 2092 | 4.7 |
| 4 | 6.8 | 3006 | 203.3 | 11.62 | — | — | 6.8 | 3.9 | 2160 | 315.9 | 11.04 | 3.5 | 1922 | 3.9 |
| 5 | 7.3 | 2525 | 164.0 | 10.41 | — | — | 7.3 | 3.8 | 1781 | 104.2 | 3.76 | 3.9 | 1802 | 3.9 |
| Avg | 5.9 | 2674 | 174.8 | 8.89 | 5.0 | 2283 | 5.9 | 4.1 | 2072 | 229.4 | 8.45 | 3.8 | 1944 | 4.1 |
| StDev | 1.13 | 203 | 34.24 | 2.65 | — | — | 1.13 | 0.38 | 187 | 85.70 | 3.21 | 0.35 | 143 | 0.35 |

The seventh measurement was an oxygen transmission rate measurement and Tables 9 and 10 shows the results of the measurements.

TABLE 9
Results of Oxygen Transmission Rate Measurements in Dry Conditions
OXYGEN Transmission Rate, Dry

| | cc per 100 in² · 24 hrs | | | cc per m² · 24 hrs | | |
|---|---|---|---|---|---|---|
| Sample | rep1 | rep2 | avg | rep1 | rep2 | avg |
| A | <0.013 | <0.013 | — | <0.013 | <0.013 | — |
| B | <0.013 | <0.013 | — | <0.013 | <0.013 | — |

23° C./73° F., 0% RH (carrier/permeant); 100% O2; O₂ to outside

TABLE 10
Results of Oxygen Transmission Rate Measurements in Humid Conditions
OXYGEN Transmission Rate, High Humidity

| | cc per 100 in² · 24 hrs | | | cc per m² · 24 hrs | | |
|---|---|---|---|---|---|---|
| Sample | rep1 | rep2 | avg | rep1 | rep2 | avg |
| A | 6.1439 | 4.7183 | 5.431 | 95.23 | 73.13 | 84.18 |
| B | 13.0313 | 15.1730 | 14.102 | 201.99 | 235.18 | 218.58 |

23° C./73° F., 85% RH (carrier/permeant); 100% O2; O₂ to outside

The eight measurement was a vapor transmission rate measurement and Table 11 shows the results of the measurements.

TABLE 10
Results of Vapor Transmission Rate Measurements
MOISTURE Vapor Transmission Rate

| | grams per 100 in² · 24 hrs | | | grams per m² · 24 hrs | | |
|---|---|---|---|---|---|---|
| Sample | rep1 | rep2 | avg | rep1 | rep2 | avg |
| A | 6.288 | 6.278 | 6.283 | 97.47 | 97.31 | 97.39 |
| B | 6.176 | 6.177 | 6.176 | 95.73 | 95.74 | 95.73 |

37° C./100° F. @ 90% RH, Moisture to sealant

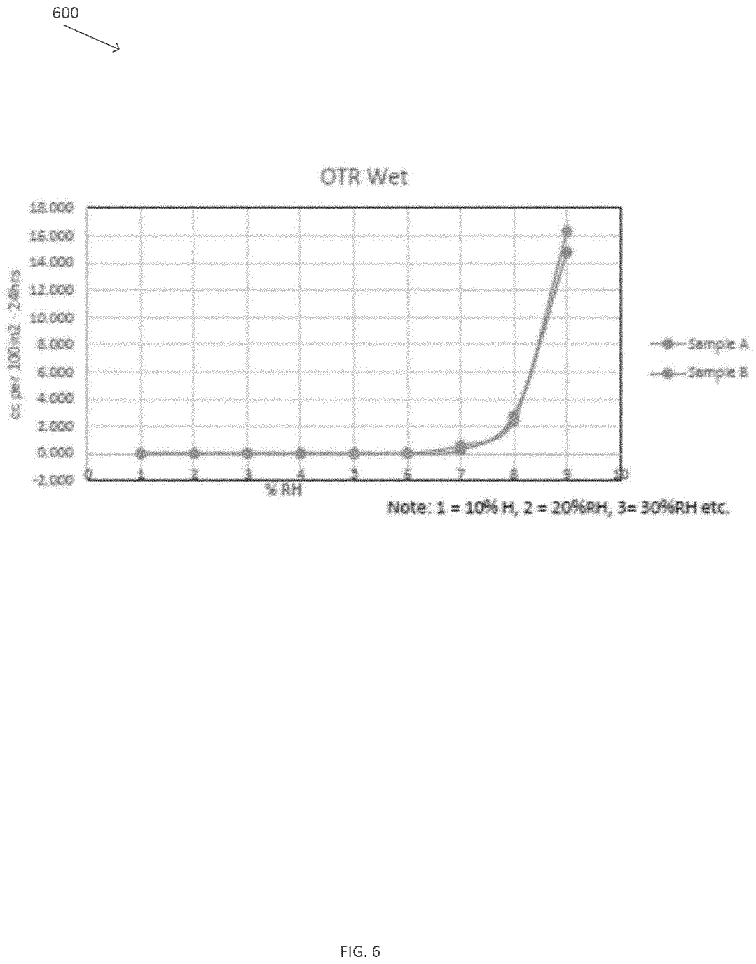

The ninth measurement was another oxygen transmission rate measurement and Tables 11 and 12 shows the results of the measurements. Additionally, FIG. 6 illustrates a graph 600 of the results tabulated in Tables 11 and 12.

TABLE 11
Results of Oxygen Transmission Rate Measurements in High Humidity
OXYGEN Transmission Rate, High Humidity

| | cc per 100 in² · 24 hrs | | | cc per m² · 24 hrs | | |
|---|---|---|---|---|---|---|
| Sample | rep1 | rep2 | ave | rep1 | rep2 | ave |
| A 10% RH | <0.013 | <0.013 | — | <0.20 | <0.20 | — |
| A 20% RH | 0.0005 | 0.0003 | 0.000 | 0.007 | 0.005 | 0.01 |
| A 30% RH | <0.013 | <0.013 | — | <0.20 | <0.20 | — |
| A 40% RH | <0.013 | <0.013 | — | <0.20 | <0.20 | — |
| A 50% RH | 0.0034 | 0.0003 | 0.002 | 0.05 | 0.00 | 0.03 |
| A 60% RH | 0.0257 | 0.0189 | 0.022 | 0.40 | 0.29 | 0.35 |
| A 70% RH | 0.3091 | 0.2419 | 0.275 | 4.79 | 3.75 | 4.27 |
| A 80% RH | 2.6013 | 2.8557 | 2.729 | 40.32 | 44.26 | 42.29 |
| A 90% RH | 13.7223 | 15.8292 | 14.776 | 212.70 | 245.35 | 229.02 |

23° C./73° F., Variable RH (carrier/permeant); 100% O₂; O₂ to outside

TABLE 12
Results of Oxygen Transmission Rate Measurements in High Humidity
OXYGEN Transmission Rate, High Humidity

| | cc per 100 in² · 24 hrs | | | cc per m² · 24 hrs | | |
|---|---|---|---|---|---|---|
| Sample | rep1 | rep2 | ave | rep1 | rep2 | ave |
| B 10% RH | <0.013 | <0.013 | — | <0.20 | <0.20 | — |
| B 20% RH | 0.0012 | 0.0011 | 0.001 | 0.02 | 0.02 | 0.02 |
| B 30% RH | <0.013 | <0.013 | — | <0.20 | <0.20 | — |
| B 40% RH | <0.013 | <0.013 | — | <0.20 | <0.20 | — |
| B 50% RH | 0.0016 | 0.0003 | 0.001 | 0.03 | 0.01 | 0.02 |
| B 60% RH | 0.0280 | 0.0139 | 0.021 | 0.43 | 0.22 | 0.32 |
| B 70% RH | 0.4233 | 0.7751 | 0.599 | 6.56 | 12.01 | 9.29 |
| B 80% RH | 2.0586 | 2.6947 | 2.377 | 31.91 | 41.77 | 36.84 |
| B 90% RH | 20.0661 | 12.5998 | 16.333 | 311.02 | 195.30 | 253.16 |

23° C./73° F., Variable RH (carrier/permeant); 100% O₂; O₂ to outside

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A film structure comprising:
a first outer layer system comprising at least one layer formed of a starch polymer thermoplastic bioresin;
a core layer system comprising at least one layer formed of a modified Polyvinyl Alcohol (PVOH); and
a second outer layer system comprising at least one layer formed of a starch polymer thermoplastic bioresin;
wherein the first outer layer system, the second outer layer system, and the core layer system are compostable.

2. The film structure of claim 1, wherein the at least one layer of the core layer system is water soluble and is configured to resist permeation of water vapor through the first outer layer system.

3. The film structure of claim 1, wherein the first outer layer system comprises a plurality of layers.

4. The film structure of claim 3, wherein the first outer layer system comprises a first layer, a second layer, and a third layer.

5. The film structure of claim 4, wherein the first layer, the second layer, and the third layer are configured to resist permeation of water vapor through the first outer layer system.

6. The film structure of claim 4, wherein the first layer, the second layer, and the third layer comprise BIOPLAST GF106/02® from BIOTEC®.

7. The film structure of claim 1, wherein the core layer system comprises a plurality of layers.

8. The film structure of claim 7, wherein the core layer system comprises a fourth layer, a fifth layer, and a sixth layer.

9. The film structure of claim 8, wherein the fourth layer and the sixth layer are tie layers comprising a biodegradable resin.

10. The film structure of claim 9, wherein the fourth layer and the sixth layer comprise Nichigo G-Polymer Biodegradable Resin BTR8002P® from Mitsubishi Chemical Corp.®.

11. The film structure of claim 8, wherein the fifth layer is a barrier layer comprising a Butendiol Vinyl Alcohol co-Polymer (BVOH).

12. The film structure of claim 9, wherein the fifth layer comprises Nichigo G-Polymer BVE 8049P® from Mitsubishi Chemical Corp.®.

13. The film structure of claim 1, wherein the second outer layer system comprises a plurality of layers.

14. The film structure of claim 13, wherein the second outer layer system comprises a seventh layer, an eighth layer, and a ninth layer.

15. The film structure of claim 14, wherein the seventh layer, the eighth layer, and the ninth layer are configured to resist permeation of water vapor through the first outer layer system.

16. The film structure of claim 15, wherein the seventh layer, the eighth layer, and the ninth layer comprise BIOPLAST GF106/02® from BIOTEC®.

17. A film structure comprising:
a first outer layer system comprising at least one layer formed of a starch polymer thermoplastic bioresin and configured to resist permeation of at least one of water vapor and oxygen through the first outer layer system within a first temperature and/or humidity range;
a second outer layer system comprising at least one layer formed of a starch polymer thermoplastic bioresin and configured to resist permeation of at least one of water vapor and oxygen through the second outer layer system within the first temperature and/or humidity range; and
a core layer system comprising at least one layer formed of a modified Polyvinyl Alcohol (PVOH) and configured to resist permeation of oxygen through the core layer system within the first temperature and/or humidity range, wherein the first outer layer system, the second outer layer system, and the core layer system are compostable within a second temperature and/or humidity range.

18. The film structure of claim 17, wherein the at least one layer of the core layer system is water soluble.

19. The film structure of claim 17, wherein a first temperature range of the first temperature and/or humidity range is about 32° F. to about 40° F.

20. A method of manufacturing a film structure with an extrusion system, the extrusion system including a plurality of extruders, a feedblock, and a die, the method comprising:
extruding at least one first material using the extruders to generate at least one first melt stream;
feeding the first melt stream to the feedblock, wherein the first melt stream forms a first outer layer system;
extruding at least one second material using the extruders to generate at least one second melt stream;
feeding the second melt stream to the feedblock, wherein the second melt stream forms a core layer system;
extruding at least one third material using the extruders to generate at least one third melt stream;
feeding the third melt stream to the feedblock, wherein the third melt stream forms a second outer layer system;
combining the first outer layer system, the core layer system, and the second outer layer system to form a combined melt stream using the feedblock; and
feeding the combined melt stream through a die to form a cylindrical sheet, wherein the first outer layer system, the core layer system, and the second outer layer system are compostable.
